(19) United States
(12) Patent Application Publication
(10) Pub. No.: US 2012/0230028 A1
(43) Pub. Date: Sep. 13, 2012

(54) HEAT SINK DEVICE FOR LAMP AND LED LAMP COMPRISING THE SAME

(75) Inventor: Onn Fah Foo, Kowloon (HK)

(73) Assignee: MASS TECHNOLOGY (H.K.) LIMITED, Kowloon (HK)

(21) Appl. No.: 13/412,867

(22) Filed: Mar. 6, 2012

(30) Foreign Application Priority Data
Mar. 11, 2011 (CN) 201110065845.5

(51) Int. Cl. F21V 29/00; F28F 7/00; F21V 7/00

(52) U.S. Cl. 362/235; 362/249.02; 165/185

(57) ABSTRACT

The invention provides a heat sink device for a lamp, comprising a base connected to a heat source in a thermally conductive manner; and a plurality of posts extending from said base in spaced relation from one another to surround and define a hollow chamber, such that a plurality of gaps are formed on a side circumferential surface of said chamber. The heat sink device has advantages of good thermal dissipation, compact structure, small size and light weight, conservation of raw materials and reduced manufacturing costs. The invention also relates to a LED lamp comprising the heat sink device.

### FIELD OF THE INVENTION

The present invention is generally in the field of lighting fixtures. More specifically, the present invention concerns a heat sink device having increased radiation efficiency and light and compact structure, and to a LED lamp comprising the heat sink device.

### BACKGROUND OF THE INVENTION

LEDs (light-emitting diodes) are a solid state light source with long life span, firm structure, low power consumption and flexible dimension, and considerable concerns are arisen over the LEDs. In recent years, LED lamps are becoming inexpensive and prone to take the place of conventional lamps in a wide range of lighting applications. However, the LED lamps would generate relatively high heat energy at work. If the heat energy is not successfully dissipated, this will gradually increase a temperature of the LED light source to the temperature at which the LED light source cannot operate stably, with a result of impaired performance and shortened life span of the LED lamps. This leads to limited applications of the LED lamps to some extent.

A variety of mechanisms have been proposed in an attempt to solve the heat dissipation problem associated with the LED lamps. Normally, the LED lamp is provided with a heat sink device of active or passive type to cool the LED light source down, in order that the LED light source may operate at a desirable temperature. As to the heat sink device of passive type, it is required to increase the dimension of the device to increase the heat transfer area for the sake of increased radiation efficiency. Consequently, the passive heat sink device is rather bulky and heavy. The heat sink device of active type, for example an electrical fan, can reduce the dimension of the device to some extent, but it suffers from the drawbacks including high noise, high power consumption, and susceptibility to accumulation of dusts.

Presently, a common feature of heat sink devices known in the art is that the devices comprise a cylinder with a continuous side periphery on which a plurality of fins are formed. The heat generated by the LED light source is convected to the ambient through the fins and radiated to the ambient. To increase the heat transfer area, it is necessary to provide more fins or structurally modify the fins for better efficiency.

For example, Chinese Utility Model Patent No. ZL200720122176.X with the title “Heat Sink for LED lamp and LED Lamp” discloses a heat sink comprising a plurality of fins, each of which has two points of A and B at a central line of its cross section, wherein the point A, the point B and a central point of the cross section of the heat sink form a triangle. The radiating area of the heat sink of this patent is increased in comparison to the heat sink having straight fins, thereby quickening the radiation speed. However, such a heat sink not only requires more materials to manufacture the fins, but also is very bulky. As a result, the LED lamp comprising it is heavy and bulky.

Another type of heat sink device is disclosed in Chinese Patent Application No. 201010177036.9 with the title “Heat Sink Device and LED Lamp Comprising the Same”. The heat sink device comprises a heat-dissipating body consisting of a cylindrical base and multiple fins formed around the base, and an air channel provided with a central through hole and securely connected to one end surface of the heat-dissipating body, with the through hole perpendicular to the end surface for air convection. With the arrangement of the air channel providing the air convection and ventilation, the heat sink device disclosed in the application has improved the heat-dissipating efficiency. Likewise, the arrangement of the air channel renders the device and hence the lamp to be rather bulky, and the manufacturing costs are increased too.

The currently available LED lamps are very bulky and complicated to manufacture, since their heat sink devices are heavy and structurally complex. Therefore, there is a need for improving the heat sink used for the LED lamps in terms of their thermal dissipation and compact structure, while maintaining the lamps to work stably.

### SUMMARY OF THE INVENTION

An object of the invention is to address the drawbacks in the prior art mentioned above by providing a novel heat sink device which is effective to solve the thermal dissipation of the LED lamps, and which has advantages of good thermal dissipation, compact structure, small size, light weight, conservation of raw materials and reduced manufacturing costs.

The above object can be attained by providing a heat sink device for a lamp comprising:

a base connected to a heat source in a thermally conductive manner; and

a plurality of posts extending from the base in spaced relation from one another to surround and define a hollow chamber, such that a plurality of gaps are formed on a side circumferential surface of said chamber.

In one embodiment of the invention, the base is of annular configuration and has a first end face from which the plurality of the posts extend uprightly or obliquely. In another embodiment of the invention, the annular base has a second end face from which a plurality of second posts extends uprightly or obliquely to surround and define a hollow second chamber, such that a plurality of gaps are formed on a side circumferential surface of the second chamber.

The heat sink device may further comprise a support arranged in an interior of the annular base for holding a LED light source and a securing member for securing the LED light source. The support may be screwed or snap-fitted into, or formed integrally with an internal wall of the annular base.

Preferably, each of the plurality of posts has a free end which bends slightly inward or outward, so that the end abuts against an object and holds in place.

Another aspect of the invention relates to a LED lamp comprising at least one LED light source, a lamp cap receivable in a lamp cap holder and electrically coupled to a power source, a control circuit, a housing for receiving the control circuit, and the LED lamp further comprises a heat sink device of the invention, wherein the LED light source is in thermally conductive contact with the base of the heat sink device, and at least a part of the housing with the control circuit received therein is held within the chamber defined by the plurality of posts.

An inner surface of each of the plurality of posts is advantageously spaced apart from an outer surface of the housing at a distance of at least 1 mm, allowing for the air convection between the posts and the ambient.

In one preferred embodiment of the invention, the LED lamp is the type of a LED reflector lamp with a reflector cup, wherein the heat sink device has a plurality of first posts in spaced relation from one another and extending from a first end face of its base to surround and define a first hollow chamber, and a plurality of second posts in spaced relation from one another and extending from a second end face of its base to surround and define a second hollow chamber. At least a part of the housing with the control circuit received therein is held within the first chamber, and at least a part of the reflector cup is held within the second chamber. Preferably, the second hollow chamber is shaped and dimensioned to mate with the reflector cup, such that the reflector cup is completely held in the second hollow chamber. An inner surface of each of the plurality of first posts is spaced apart from an outer surface of the housing at a distance of at least 1 mm, and an inner surface of each of the plurality of second posts is spaced apart from an outer surface of the reflector cup at a distance of at least 1 mm, allowing for air convection between the first and second posts and the ambient.

In another preferred embodiment of the invention, the lamp comprises two heat sink devices of the invention, with their bases attached together and their respective posts extending in an opposite direction. One of the hollow chambers of the heat sink devices is used to receive at least a part of the housing and the control circuit, the other is used to receive at least a part of the reflector cup. An inner surface of each of the plurality of posts is spaced apart from an outer surface of the housing and from an outer surface of the reflector at a distance of at least 1 mm, respectively.

The heat sink device may comprise a support arranged in an interior of the base, and the LED light source is mounted on the support. Alternatively, the LED light source is secured on a heat conducting means which is then mounted on the support.

Preferably, each of the plurality of posts has a free end which bends slightly inward or outward, such that the free end abuts against the outer surface of the housing and holds in place.

The heat sink device may be formed with a thermally conductive material selected from the group consisting of aluminium, aluminium alloy, ceramic, thermally conductive plastics and graphite, and the housing may be formed with a non-electrically conductive material selected from plastics or glass.

Unlike the prior art heat sink devices which have a cylinder with a continuous side periphery on which a plurality of fins are formed, the heat sink device of the invention is characterized by a hollow chamber surrounded by a plurality of posts in spaced relation from one another to form a plurality of gaps on the side circumferential surface of the chamber, thereby enabling better air ventilation. In particular, the air within the hollow chamber of the heat sink device according to the invention would absorb the heat generated from the LED light source and becomes hot, the hot air then rises and spreads through the plurality of gaps, and the cool air originating from the ambient would subsequently enter into the hollow chamber from the lower part of the heat sink device. As a consequence, the air convection between the ambient and the heat sink device can be performed quickly and effectively. In addition, the heat sink device of the invention possesses the advantages of simple structure, light weight, small size, conservation of raw materials and reduced manufacturing costs.

The objects, characteristics, advantages and technical effects of the invention will be further elaborated in the following description of the concepts and structures of the invention with reference to the accompanying drawings.

### BRIEF DESCRIPTION OF THE DRAWINGS

FIG. 1 is a perspective view of a heat sink device constructed according to one embodiment of the invention.

FIG. 2 is a front view of the heat sink device of FIG. 1.

FIG. 3 is a bottom view of the heat sink device of FIG. 1.

FIG. 4 is a top view of the heat sink device of FIG. 1.

FIG. 5 is a perspective view of a LED lamp constructed according to a first embodiment of the invention.

FIG. 6 is an exploded elevation view of the LED lamp of FIG. 5.

FIG. 7 is a perspective view of a LED lamp constructed according to a second embodiment of the invention.

FIG. 8 is an exploded perspective view of the LED lamp of FIG. 7.

### DETAILED DESCRIPTION OF THE INVENTION

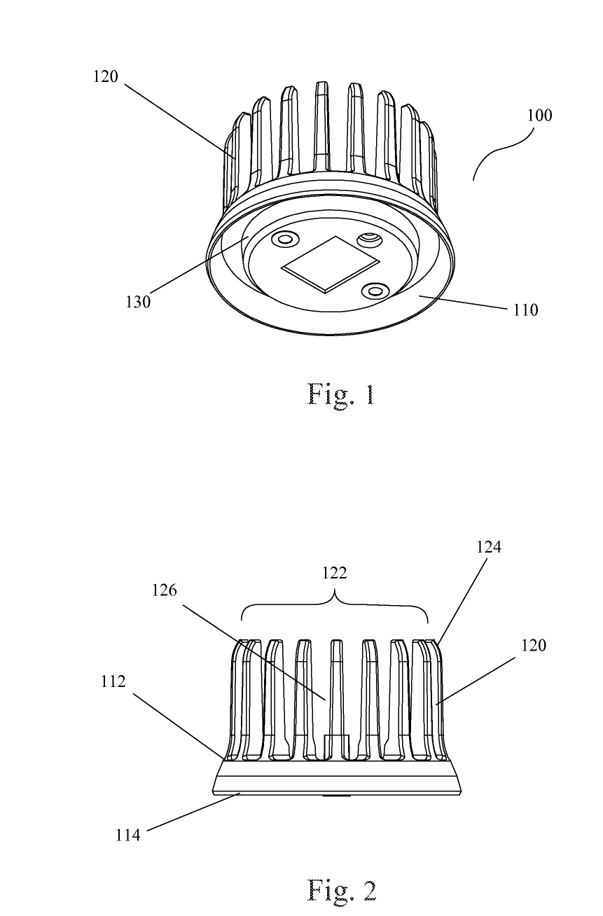

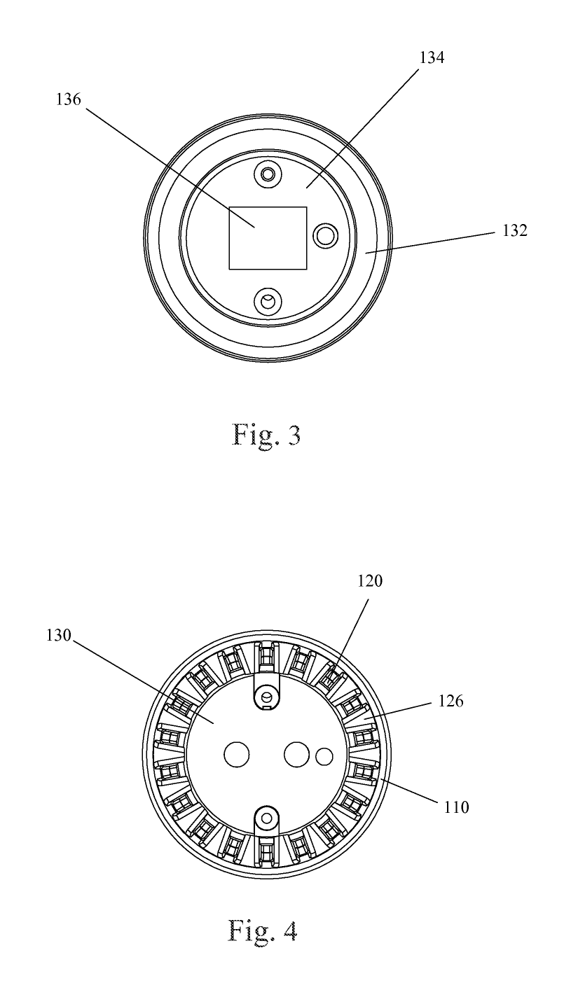

Referring to FIGS. 1 to 4, there is illustrated a heat sink device 100 constructed according to a preferred embodiment of the invention. The heat sink device 100 comprises a base 110 having a first end face 112 and a second end face 114, and a plurality of posts 120 in spaced relation from one another and extending uprightly from the first end face 112 of the base 110. It would be within the ability of the skilled person in the art that the plurality of posts may extend from the first end face 112 of the base 110 obliquely or in meandering or curved manner. In this embodiment, the base is of annular configuration, and the posts are in the shape of cuboid. Of course, the base and the posts may be of any configuration, for example, the posts may be made in the form of cylinder.

As illustrated, the spaced posts 120 surround to define a hollow chamber 122, such that a plurality of gaps 126 are formed on a side circumferential surface of the chamber constructed by the plurality of posts. The cross sectional area of the post and the gap size between the adjacent two posts depend on the size of the LED lamp. In order for a better heat transfer effect, the cross sectional area of the post is preferably not too small. In addition, it is noted that small gap size between the adjacent posts will affect the effects of the air ventilation and the air convection.

The post 120 has a free end 124 which bends slightly inward or outward, such that the free end 124 may abut against or grasp the other parts of the lamp to hold the heat sink device 100 in place, when the device 100 is mounted onto the lamp, which will be discussed hereinbelow.

As a variation, a plurality of second posts in spaced relation extend from the second end face 114 of the base 110 to surround and define a second hollow chamber, such that a plurality of gaps are formed on a side circumferential surface of the second chamber (not shown). This variation enriches the design of the LED lamp, for example, the different parts of the lamp may be received and held in two different chambers of the heat sink device, according to the actual needs and design requirements.

FIGS. 1, 3 and 4 illustrate that the heat sink device 100 comprises a support 130 arranged in an interior of the base 110, and the support 130 is made up of a bottom 132 and a boss part 134 extending from the bottom 132. The bottom 132 and the inner wall of the base 110 may be secured together by screws or snap-fitting. Of course, the bottom 132, the boss part 134 and the base 110 may be formed integrally. Positioned at a center of the boss part 134 is a square recess 136 onto which one or more LED light sources may be directly secured. Alternatively, one or more LED light sources are secured on a light source panel which is then secured on the square recess 136. As a second alternative, one or more LED light sources are secured on a light source panel mounted on a heat-conducting means, and the heat conducting means with the LED light source is then secured onto the recess 136. These technologies are well known in the art and will not be described in details herein.

The base 110, the posts 120 and the support 130 of the heat sink device may be formed with a thermally conductive material, for example aluminium, aluminium alloy, ceramic, thermally conductive plastics or graphite. Then, the heat generated by the LED light source mounted on the recess 136 will be transferred to the posts 120 through the support 130 and the base 110, and the air surrounding the posts will be heated by the heated posts. Because of the gaps 126 of the heat sink device, the heated air can rise and spread out through the plurality of gaps 126, and the cool air can recruit after the spread of the heated air, thereby facilitating the air convection for better heat dissipation.

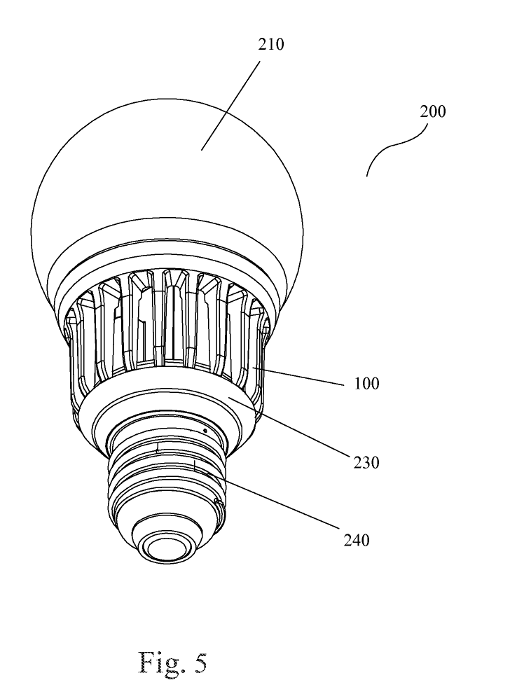

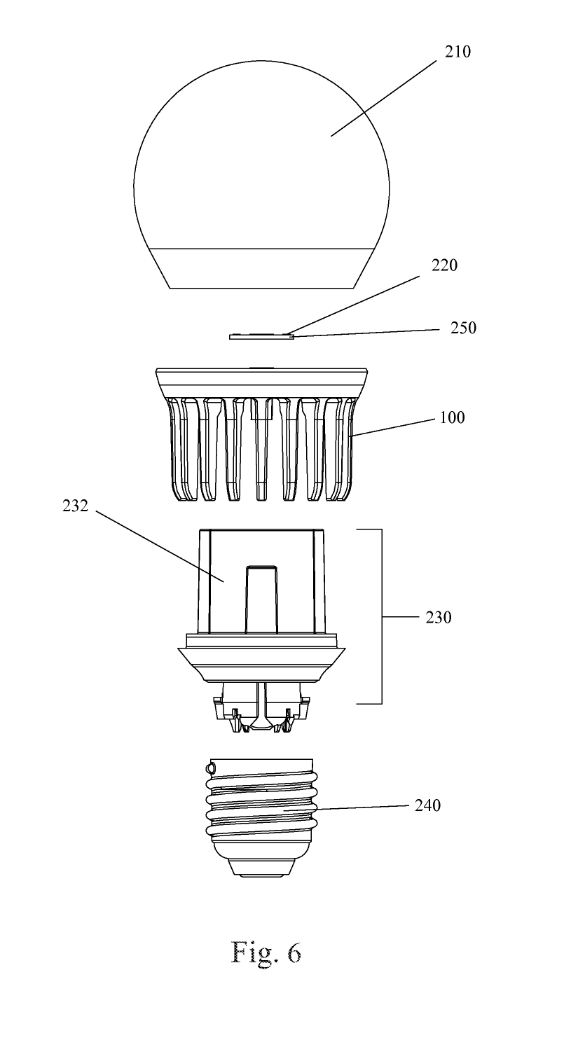

FIGS. 5 and 6 illustrate a LED lamp 200 constructed according to a first embodiment of the invention, comprising the heat sink device 100 discussed above. The LED lamp 200 further comprises a glass bulb shell 210, a LED light source 220, a housing 230, a lamp cap 240 and a control circuit (not shown).

The glass bulb shell 210 may be transparent, or selected from the group consisting of glass bulb shell with injected silicon coating, glass bulb shell with torsional lines, and frosted glass bulb shell according to the actual needs. The lamp cap 240 may be of various sizes according to the actual needs, for instance, the lamp cap 240 may be selected from the group of E14, E26 and E27 lamp caps. The control circuit can be of any type known in the art, and is not the essence of the invention, therefore not described in detail herein.

The LED light source 220 can consist of one or more LED chips. In this embodiment, the LED light source 220 consists of multiple LED chips which are secured on a light source panel 250. The LED light source 220 can be secured on the light source panel 250 by glue dispensing or mechanically or any means known in the art. Then the light source panel 250 with the LED light source is mounted on the recess 136 of the heat sink device. The mounting can be performed using a technique known in the art, provided that they can create good performances of thermal conduction and thermal dissipation therebetween. For example, they can be attached to each other through a viscous radiating oil.

The housing 230 is formed with a non-electrically conductive material such as glass or plastics to provide the insulation. The housing 230 comprises a case 232 having a receiving chamber in which the control circuit is placed. A part of the housing 230 with the control circuit therein is received in the hollow chamber 122 surrounded by the plurality of posts of the heat sink device 100. In this embodiment, each of the posts 120 has a free end 124 which bends slightly inward, so that it can abut against and grasp the outer surface of the trapeziform lower part of the housing 230 to hold the post 120 in place.

The outer surface of the case 232 of the housing 230 is spaced apart from the inner surface of the post 120 of the heat sink device 100, preferably at a distance of at least 1 mm.

Thus, the case 232 and the post 120 together define a space which allows for better air convection so that the heated air can be dissipated quickly.

The second end face 114 of the heat sink device 100 can be coupled to the glass bulb shell 210 by any means known in the art, for example snap-fit, screws or glues.

The light source panel 250 and the heat sink device 100 are preferably formed with a thermally conductive material, for example aluminium, aluminium alloy, ceramic, thermally conductive plastics and graphite.

Because the light source panel 250 on which the LED light source is secured lies tightly against the support 130 of the heat sink device 100, and the support 130 is in thermally conductive contact with the base 110 of the heat sink device, thereby the heat generated by the LED light source can be transferred to the plurality of posts 120. The air within the space defined by the case 232 and the posts 120 is then heated by the posts and dissipated through the plurality of the gaps 126, while the cool air will recruit after the dissipation of the heated air. This greatly increases the efficiency of heat dissipation and hence reduces the temperature of the LED light source, which is a practical solution to the heat dissipation problem associated with the LED lamps.

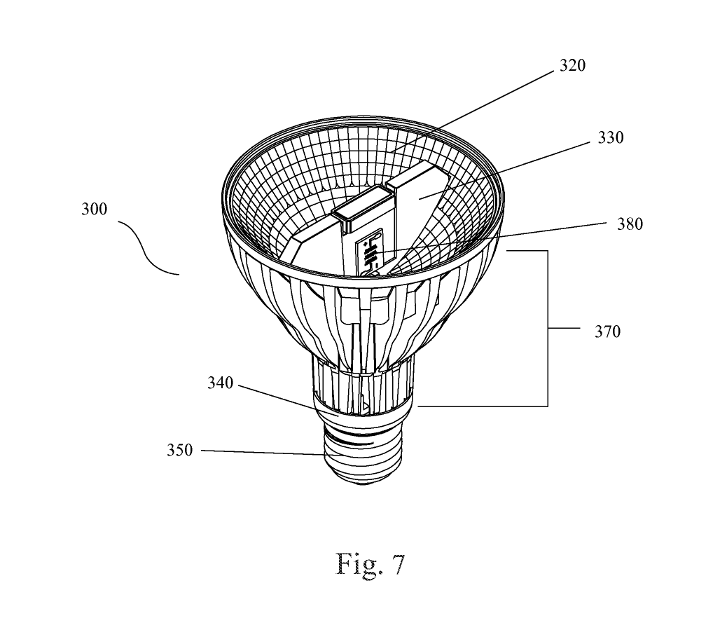

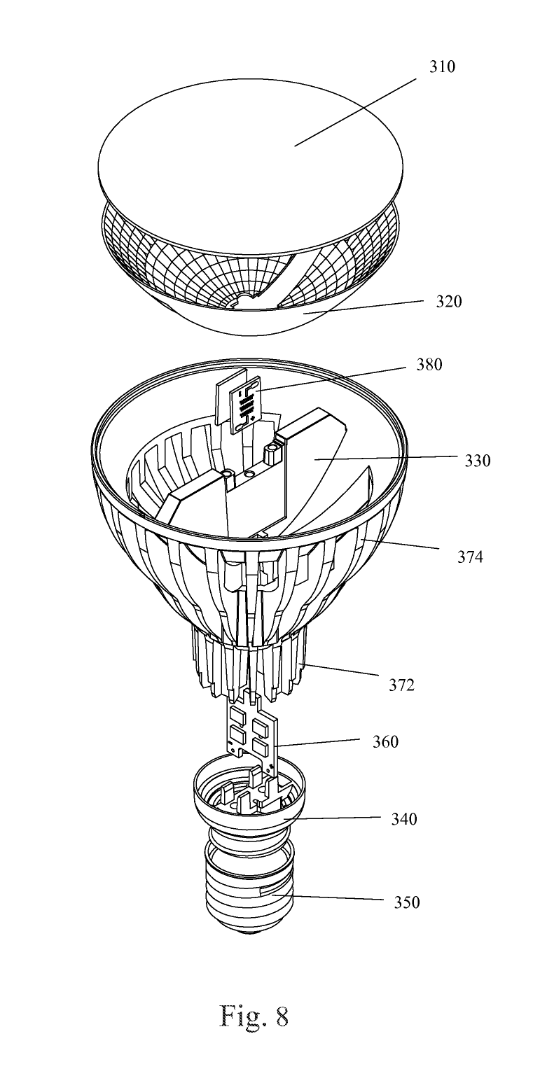

FIGS. 7 and 8 illustrate a LED reflector lamp 300 constructed according to a second embodiment of the invention, comprising the heat sink device 370. The LED reflector lamp 300 further comprises a glass lampshade 310, a reflector cup 320, a heat-conducting plate 330, a LED light source 380, a housing 340, and lamp cap 350 and a control circuit 360.

The glass lampshade 310 is smooth and transparent. In some applications, the glass lampshade 310 may not be provided if desirable.

Reference of the design of the LED light source 380, the reflector cup 320 and the heat-conducting plate 330 may be made to the Chinese patent application no. 200910002486.1 of the applicant, the full disclosure of which is incorporated herein in its entirety.

The housing 340, the lamp cap 350 and the control circuit 360 may be made reference to the first embodiment discussed above, or varied according to the actual needs, and are not described here.

The heat sink device 370 is a variation of the heat sink device 100 of the above first embodiment. In particular, a plurality of first posts 372 in spaced relation and a plurality of second posts 374 in spaced relation extend from the first end face and the second end face of the base, respectively. The first posts 372 surround and define a first hollow chamber, and the second posts 374 surround and define a second hollow chamber.

As illustrated, the first chamber defined by the first posts 372 is cylindrical for receiving a part of the housing 340 and the control circuit 360 placed in the housing 340, and substantially same as the one discussed in the above first embodiment. Likewise, the outer surface of the case of the housing 340 is spaced apart from the inner surface of each of the plurality of first posts 372 at a distance of at least 1 mm for better air convection and quick heat dissipation.

In this embodiment, the second posts 374 have a cross section of sector and define the second hollow chamber which is substantially horn-shaped in order to mate with the reflector cup 320 in the horn shape, allowing the reflector cup 320 to be completely received in the second hollow chamber. The outer surface of the reflector cup 320 is also spaced apart from the inner surface of each of the second posts 374, preferably at a distance of at least 1 mm. Therefore, the reflector cup 320 and the second posts 374 define a space which increases and facilitates the air convection and the heat dissipation.

The heat-conducting plate 330 secured with the LED light source 380 and the light source panel is inserted through a through slot formed on the bottom of the reflector cup 320 into the interior of the reflective cup, and mounted on the recess of the support of the heat sink device. In this embodiment, the heat-conducting plate 330 is arranged such that the centrally vertical axis of the heat-conducting plate 330 overlaps the centrally vertical axis of the reflective cup 320. Such a configuration enables to give out an uniform light distribution and obtain an enhanced luminous efficiency.

In the LED reflector lamp of this embodiment, the LED light source 380 and the light source panel tightly come into contact with the heat-conducting plate 330 which is integral with the base of the heat sink device through the slot formed on the bottom of the reflector cup, so as to create a path for good thermal conduction and thermal dissipation. This path allows the heat generated from the LED light source to be transferred successfully through the light source panel—the heat-conducting plate—the base of the heat sink to the first posts 372 and the second posts 374 to get heated. The air surrounding the first and second posts is subsequently heated. The heated air is spread out through the plurality of gaps between the first posts and the plurality of gaps between the second posts, and the cool air would recruit after the spread of the heated air, therefore the air convection is quickened. The arrangement of the first posts 372 and the second posts 374 also increases the efficiency of the heat dissipation between the heat sink device and the ambient, which further reduces the temperature of the LED light source.

Another variation of the invention is that the LED lamp comprises two heat sink devices 100 discussed above, which are arranged such that their bases are fixed together and their respective posts face in an opposite direction. The hollow chamber of one of the heat sink devices is used for holding at least a part of the housing and the control circuit, and the chamber of the other heat sink device is used for holding the reflector cup and the heat-conducting plate.

Thus, the present invention provides a heat sink device for LED lamps, whose hollow chamber is surrounded by a plurality of posts in spaced relation. This design not only saves a large amount of raw materials for manufacturing the cylinder of the heat sink device, but also has a simple structure, light weight and small size. It has been found that the LED lamps using the heat sink device of the invention greatly enhances and quickens the heat dissipation, increases the luminous efficiency, prolongs the life of the lamp, and makes it possible that the LED lamp can be of small size. The heat dissipation is further improved if the inner surface of the posts of the heat sink device is spaced apart from the other parts of the lamp at a distance of at least 1 mm.

Having sufficiently described the nature of the present invention according to some preferred embodiments, the invention, however, should not be limited to the structures and functions of the embodiments and drawings. It is stated that insofar as its basic principle is not altered, changed or modified it may be subjected to variations of detail. Numerous variations and modifications that are easily obtainable by means of the skilled person's common knowledge without departing from the scope of the invention should fall into the scope of this invention.

What is claimed is:

1. A heat sink device for a lamp, characterized by comprising:
a base connected to a heat source in a thermally conductive manner; and
a plurality of posts extending from said base in spaced relation from one another to surround and define a hollow chamber, such that a plurality of gaps are formed on a side circumferential surface of said chamber.

2. A heat sink device according to claim 1, characterized in that said base is of annular configuration and has a first end face from which the plurality of the posts extend uprightly or obliquely.

3. A heat sink device according to claim 2, characterized in that said annular base has a second end face from which a plurality of second posts extends uprightly or obliquely to surround and define a hollow second chamber, such that a plurality of gaps are formed on a side circumferential surface of said second chamber.

4. A heat sink device according to claim 2, characterized in that said heat sink device further comprises a support arranged in an interior of said annular base for holding a light source and a securing member for securing the light source.

5. A heat sink device according to claim 4, characterized in that the support is screwed or snap-fitted into, or formed integrally with an internal wall of said annular base.

6. A heat sink device according to claim 1, characterized in that each of the plurality of posts has a free end which bends slightly inward or outward.

7. A LED lamp comprising at least one LED light source, a lamp cap receivable in a lamp cap holder and electrically coupled to a power source, a control circuit, a housing for receiving said control circuit, characterized in that said LED lamp further comprises a heat sink device according to claim 1, wherein said LED light source is in thermally conductive contact with said base of said heat sink device, and at least a part of said housing with said control circuit received therein is held within said chamber defined by the plurality of posts.

8. A LED lamp according to claim 7, characterized in that an inner surface of each of the plurality of posts is spaced apart from an outer surface of said housing at a distance of at least 1 mm.

9. A LED lamp according to claim 7, characterized in that said heat sink device is as defined in claim 3, and said lamp further comprises a reflector cup, wherein at least a part of said housing with said control circuit received therein is held within said chamber defined by the plurality of posts, and at least a part of said reflector cup is held within said second chamber defined by the plurality of second posts.

10. A LED lamp according to claim 9, characterized in that an inner surface of each of the plurality of posts is spaced apart from an outer surface of said housing at a distance of at least 1 mm, and an inner surface of each of the plurality of second posts is spaced apart from an outer surface of said reflector cup at a distance of at least 1 mm.

11. A LED lamp according to claim 9, characterized in that each of the plurality of second posts has a free end which bends slightly inward or outward, such that said free end abuts against said outer surface of said reflector cup.

12. A LED lamp according to claim 7, characterized in that said LED lamp further comprise another heat sink device according to any one of claims 1 to 6 and a reflector cup, wherein said two heat sink devices are arranged such that their bases are fixed together and face in an opposite direction, and at least a part of said reflector cup is held within said chamber of said another heat sink device.

13. A LED lamp according to claim 12, characterized in that an inner surface of each of the plurality of posts of said another heat sink device is spaced apart from an outer surface of said reflector cup at a distance of at least 1 mm.

14. A LED lamp according to claim 7, characterized in that said heat sink device comprises a support arranged in an interior of said base, and said LED light source is mounted on said support.

15. A LED lamp according to claim 7, characterized in that said heat sink device comprises a support arranged in an interior of said base, and a heat conducting mean on which said light source is secured is mounted on said support.

16. A LED lamp according to claim 7, characterized in that each of the plurality of posts has a free end which bends slightly inward or outward, such that said free end abuts against an outer surface of said housing.

17. A LED lamp according to claim 7, characterized in that said heat sink device is formed with a thermally conductive material, said housing is formed with a non-electrically conductive material.

18. A LED lamp according to claim 17, characterized in that said thermally conductive material is selected from the group consisting of aluminium, aluminium alloy, ceramic, thermally conductive plastics and graphite.

19. A LED lamp according to claim 17, characterized in that said non-electrically conductive material is selected from plastics or glass.
